(19) United States
(12) Patent Application Publication
(10) Pub. No.: US 2011/0164647 A1
(43) Pub. Date: Jul. 7, 2011

(54) EXCIMER LASER DEVICE

(76) Inventors: Shinji NAGAI, Hiratsuka-shi (JP); Kouji KAKIZAKI, Hiratsuka-Shi (JP); Tsukasa HORI, Naka-gun (JP); Satoshi TANAKA, Saitama-shi (JP)

(21) Appl. No.: 13/048,159

(22) Filed: Mar. 15, 2011

Related U.S. Application Data
(62) Division of application No. 11/882,938, filed on Aug. 7, 2007.

(30) Foreign Application Priority Data
Aug. 9, 2006 (JP) 2006-216915

(51) Int. Cl. H01S 3/22

(52) U.S. Cl. 372/57

(57) ABSTRACT

An excimer laser device capable of suppressing deterioration of optical elements provided in a laser chamber even if output energy per pulse is increased more than the conventional level, in which a width of a laser beam applied to the optical elements provided in the laser chamber is enlarged so as to reduce the energy density of the laser beam within such a range that a laser output of no less than a desired level is obtained.

### CROSS-REFERENCE TO RELATED APPLICATION

This application is a divisional of U.S. application Ser. No. 11/882,938, filed Aug. 7, 2007, the entirety of which is incorporated herein by reference.

### BACKGROUND OF THE INVENTION

1. Field of the Invention

The present invention relates to a gas laser device, and in particular to a high output excimer laser device for exposure.

2. Description of the Related Art

A demand for improving the resolution of exposure devices for semiconductor substrates has arisen along with the recent advancement of refinement and integration of semiconductor integrated circuits. In order to meet this demand, studies have been made to shorten the wavelength of a laser beam emitted from an exposure light source. One type of typically used semiconductor exposure light source is gas laser devices which emit light with a shorter wavelength than that of conventional mercury lamps. As gas laser devices for exposure, KrF excimer laser devices emitting ultraviolet light having a wavelength of 248 nm and ArF excimer laser devices emitting ultraviolet light having a wavelength of 193 nm are typically used.

In recent years, there has been a trend of increased demand for excimer laser devices for exposure having still higher output as the wavelength of exposure light is decreased. A main reason for the trend lies in the fact that the resist used for exposure with ArF excimer lasers has lower sensitivity than the resist used for exposure with KrF excimer lasers. A demand for increased throughput is another reason.

One type of device outputting high output laser light is an excimer laser device performing both oscillation and amplification in a single laser chamber. Such an excimer laser device will be referred to as a “single-chamber excimer laser device”.

On the other hand, amplification may be performed by a two-stage laser system as shown in FIG. 1.

The two-stage laser system is composed of an oscillation stage laser 10 for outputting narrow-band laser light, and an amplification stage laser 20 for amplifying the narrow-band laser beam (referred to as “seed light”).

Practical two-stage laser systems used are classified into two types, MOPO and MOPA systems, according to the difference in means for amplifying the laser light. A MOPO laser system includes an amplification stage laser having a resonator. The term “MOPO” is an abbreviation for master oscillator/power oscillator and is also referred to as “injection lock (IL) system”. On the other hand, a MOPA laser system includes an amplifier having no resonator. The term “MOPA” is an abbreviation for master oscillator/power amplifier. Particulars of the two-stage system will be described later.

Increase of the output of an excimer laser device can be realized, for example, by increasing the output energy per pulse if the oscillatory frequency is fixed. However, the increase of output energy per pulse will incur problems as described below.

A resonator is typically comprised of an output-side mirror for emitting laser light and a rear-side mirror having a high reflectance. The output-side mirror has a PR film (partial reflection mirror coating) with a reflectance of several tens of percent attached to one side, and an AR film (anti-reflection coating) attached to the other side. A rear-side mirror in a single laser chamber has a HR film (high reflection mirror coating) attached thereto, and a rear-side mirror in an amplification stage laser has a PR film with a high reflectance of about 80˜90% attached thereto. Laser light output from the amplification stage laser and reaching the output-side mirror is output only partially. Therefore, the laser energy inside the resonator is several times higher than the energy output to the outside.

In the case of the MOPO system, for example, a laser beam output from the oscillation stage laser exhibits an energy density of several mJ/cm². However, since the laser energy is amplified in the amplification stage laser, the laser beam inside the resonator exhibits a high energy density of several tens of mJ/cm² or higher. As a result, a laser beam with a high energy density passes through a chamber window of the amplification stage laser, and hence the amount of laser light absorbed by the surface and the inside of the window is increased, causing the window to generate heat. If this heat generation causes thermal stress in the window, a window formed from CaF₂, for example, will be deteriorated. When the deterioration of the window progresses to a certain degree, the window cannot be used as an optical element any more, coming to the end of the window's lifetime.

FIG. 2 shows experimental results indicating the relation between the output energy and the lifetime of optical elements in the MOPO laser system. In the experiments, an oscillatory frequency of 4 kHz is used.

As seen from FIG. 2, when output energy per pulse is 12 mJ under a conventional condition, the average energy density applied to the window is 33.8 mJ/cm², and the peak energy density is 91.4 mJ/cm². The window has a lifetime of 14 Bpls. The laser beam width is 0.33 cm.

In contrast, when output energy per pulse is 15 mJ under a novel condition, the average energy density applied to the window is 42.3 mJ/cm², and the peak energy density 114.2 mJ/cm². The window comes to the end of its lifetime after one Bpls. The laser beam width is 0.33 cm.

Also as for the output-side mirror, the mirror has a lifetime of 24.1 Bpls or more under the conventional condition, whereas, under the novel condition, the lifetime of the mirror is only one Bpls.

According to the comparison results described above, when the output energy is increased by about 25% compared to that of the conventional condition when the laser beam width is fixed, the lifetime of the window is decreased to one fourteenth of that of the conventional condition. It is believed that this is because, since the output laser beam width is fixed, the peak energy density or the average energy density applied to the window is increased as the output energy is increased, and the deterioration of the window rapidly progresses when the density exceeds a threshold, resulting in drastic decrease of the lifetime of the window.

As described above, the output energy is increased in the amplification stage laser of the MOPO laser system, and the lifetime of the window provided in the amplification stage laser chamber or of the output-side mirror is drastically decreased once the peak energy density or average energy density in the resonator exceeds a predetermined threshold. In principle, this also applies to the laser oscillator or laser amplifier of an excimer laser device with a single laser chamber.

Accordingly, it is envisageable to increase the cross-sectional area of a beam applied to the optical elements by enlarging the discharge electrode width for the purpose of decreasing the peak energy density.

FIG. 3 is a conceptual diagram for explaining a case in which the discharge electrode width is enlarged.

As shown in FIG. 3, discharge electrodes 24 and 25 are arranged to face each other, and a discharge electrode width T1 of the enlarged discharge electrodes is greater than the discharge electrode width T0 of a prior art. A discharge area is formed between the discharge electrodes 24 and 25, and a laser beam is amplified in this space. During oscillation, high-speed laser gas 3 flows between the discharge electrodes 24 and 25 from the left side (upstream side) to the right side (downstream side) as viewed in the figure. In the following description, the region between the discharge electrodes shall be referred to simply as the “gain region”.

However, the enlargement of the discharge electrode width will induce problems as described below.

If oscillation is repeated after simply enlarging the discharge electrode width, subsequent oscillation is performed before a discharge product generated in the gain region during the previous oscillation is sufficiently shifted. This will cause arc discharge 4 to occur on the downstream side of the discharge electrodes 24 and 25, deteriorating the stability of the output energy.

In order to prevent this arc discharge, it is envisageable to increase the flow rate of laser gas in the gain region by increasing the rotation speed N of a fan incorporated in the laser chamber.

However, when the flow rate of the laser gas is made proportional to the discharge electrode width T in order to prevent the arc discharge, the fan rotation speed N is proportional to the discharge electrode width T since the fan rotation speed N is proportional to the flow rate of the laser gas. That is, N∝T.

In general, a consumption current I of the fan is proportional to the cube of a rotation speed N of the fan. Therefore, the consumption current of the fan is proportional to the cube of the discharge electrode width T. That is, I∝T³. Thus, the consumption current of the fan is rapidly increased in proportion to the cube of the discharge electrode width. Currently, the consumption current of the fan is approximately its upper limit, and it is difficult to increase the consumption current any further. Consequently, it should be avoided to increase the rotation speed of the fan by enlarging the discharge electrode width.

### SUMMARY OF THE INVENTION

The present invention has been made in view of the problems described above. It is an object of the present invention to provide an excimer laser device capable of suppressing deterioration of optical elements provided in a laser chamber even if the output energy per pulse is increased.

In order to achieve the object above, a first aspect of the invention provides an excimer laser device having laser beam width enlarging means for enlarging a width of a laser beam applied to an optical element provided in a laser chamber so that an energy density of the laser beam is reduced within such a range that a laser output of no less than a desired level is obtained.

The first aspect of the invention will be described with reference to FIGS. 4B, 5 and 6.

As shown in FIG. 4B, a gain region width W1 can be enlarged compared to a conventional configuration by tilting a discharge electrode axis 32 with respect to a resonator optical axis 30, and hence the laser beam width can be enlarged.

On the other hand, as the tilt angle θ of the discharge electrode axis 32 is increased, the distance for which the laser beam is allowed to travel in the gain region is decreased. If the tilt angle θ is too large, it is expected that the laser beam reflected back and forth within the resonator cannot be utilized effectively in the gain region.

According to experimental results, when a gain G0 and an injected light amount are high, the output energy can be held substantially constant until the tilt angle becomes a diagonal angle θ1 shown in FIG. 5, but the output energy rapidly drops once the tilt angle exceeds the diagonal angle θ1.

This means that, as shown in FIG. 6, the laser beam width B is increased monotonically as the tilt angle θ is increased. On the other hand, if the gain G0 and the injected light amount are high, the output energy P remains substantially constant until the tilt angle reaches the diagonal angle θ1, but the output energy P rapidly drops once the tilt angle exceeds the diagonal angle θ1.

According to the first aspect of the invention, therefore, on the basis of the findings shown in FIG. 6, the width of a laser beam applied to optical elements provided in the laser chamber is enlarged by setting the tilt angle θ of the discharge electrode axis 32 with respect to the resonator optical axis 30 so that the energy density of the laser beam is decreased within such a range that a laser output of no less than a desired level is obtained. For example, in order to enlarge the laser beam width to a maximum under the condition that the output energy is fixed, the tilt angle of the discharge electrode axis 32 is set to θ1.

According to a second aspect of the invention based on the first aspect of the invention, the excimer laser device is of a single-chamber type.

The second aspect of the invention will be described with reference to FIG. 4B.

As shown in FIG. 4B, the excimer laser device has single-chamber configuration, in which laser is oscillated and amplified by discharge within a single laser chamber 23. Optical systems forming a resonator optical axis 30 are arranged on the left and right sides in the drawing.

In the single-chamber excimer laser device as well, the gain region width W1 can be enlarged by tilting the discharge electrode axis 32 with respect to the resonator optical axis 30. In this case, the tilt angle θ is set based on the findings shown in FIG. 6 to enlarge the laser beam width.

According to a third aspect of the invention based on the first aspect of the invention, the excimer laser device is used for an amplification stage laser of a two-stage laser device comprised of an oscillation stage laser and the amplification stage laser.

The third aspect of the invention will be described with reference to FIGS. 4B and 1.

The laser chamber 23 shown in FIG. 4B is the laser chamber 23 of the amplification stage laser shown in FIG. 1. Seed light generated by the oscillation stage laser 10 is injected into the laser chamber 23 and the energy of the seed light is amplified in the amplification stage laser 20.

In this configuration as well, the gain region width W1 can be enlarged by tilting the discharge electrode axis 32 with respect to the resonator optical axis 30. In this case, the tilt angle θ is set on the basis of the findings shown in FIG. 6 to enlarge the laser beam width.

According to a fourth aspect of the invention based on the second or third aspect of the invention, the excimer laser device includes a resonator comprised of a rear-side mirror and an output-side mirror both of which are of a flat type, a laser chamber arranged inside the resonator, and a pair or discharge electrodes facing each other inside the laser chamber, in which the laser beam width enlarging means tilts a resonator axis formed by arranging the rear-side mirror and the output-side mirror of the resonator parallel to each other and an axis of the discharge electrode axes extending parallel to the longitudinal direction, in a plane parallel to an electrode width direction of the discharge electrodes.

The fourth aspect of the invention will be described with reference to FIG. 12B.

In the fourth aspect of the invention, as shown in FIG. 12B, an optical axis 31 passing through the center of the chamber is tilted at a tilt angle θ with respect to the resonator optical axis 30.

According to FIG. 12B, the optical axis 31 passing through the center of the chamber is tilted with respect to the resonator optical axis 30, whereby the gain region of the discharge electrodes 24 and 25 is also tilted. Accordingly, the gain region width W1 as viewed from the direction of the resonator optical axis 30 is represented approximately by an equation, W1=W0+L sin θ, when the length of the discharge electrodes is denoted by L. Thus, the gain region width W1 is enlarged vertically by L sin θ.

Since the gain region width is enlarged by L sin θ, the width of the laser beam oscillated (amplified) in the resonator is also enlarged vertically in the drawing.

According to a fifth aspect of the invention based on the third aspect of the invention, the excimer laser device includes a resonator comprised of a rear-side mirror and an output-side mirror both of which are of a flat type, a laser chamber arranged inside the resonator, and a pair of discharge electrodes facing each other inside the laser chamber, in which the laser beam width enlarging means injects seed light generated by the oscillation stage laser into the amplification stage laser chamber, while tilting the seed light with respect to a resonator optical axis formed by arranging the rear-side mirror and the output-side mirror of the resonator parallel to each other, in a plane parallel to an electrode width direction of the discharge electrodes.

The fifth aspect of the invention will be described with reference to FIG. 14.

According to FIG. 14, seed light is injected at a tilt angle θ with respect to the resonator optical axis and reaches the output-side mirror 22. When a distance between the rear-side mirror 21 and the output-side mirror 22 is denoted by M, the injected seed light is shifted vertically on the sheet surface by M tan θ while traveling from the rear-side mirror 21 to reach the output-side mirror 22. The laser beam reflected by the output-side mirror 22 at a reflection angle θ reaches the rear-side mirror 21. The laser beam is further shifted vertically on the sheet surface by M tan θ before reaching the rear-side mirror 21. Then, the laser beam reflected by the rear-side mirror 21 at the reflection angle θ reaches the output-side mirror 22.

Subsequently, in the same manner, the laser beam is repeatedly reflected at a fixed reflection angle θ within the resonator, while the laser beam is shifted vertically on the sheet surface by M tan θ every time it is reflected. This means that the laser beam width is enlarged vertically on the sheet surface.

According to a sixth aspect of the invention based on the fifth aspect of the invention, the laser beam width enlarging means further includes means for causing the injected seed light to pass through substantially an entire gain region between the discharge electrodes.

In the sixth aspect of the invention as shown in FIG. 23B, injected seed light is shifted to the lower side in the drawing by Gm from the position indicated by the broken lines to the position indicated by the solid lines, so as to enable the seed light to pass through a partial region Gb.

Specifically, in order to shift the optical axis 35 of the injected seed light to the lower side in the drawing by Gm, the position of the laser light guide mirror 34 to reflect the optical axis of the seed light is changed from a position K0 to a position K1. The change of the reflection position from K0 to K1 shifts the optical axis 35 of the seed light to the lower side in the drawing by Gm.

According to a seventh aspect of the invention based on the third aspect of the invention, the laser beam width enlarging means includes means for injecting seed light generated by the oscillation stage laser into the amplification stage laser chamber while tilting the seed light with respect to an axis of the discharge electrode axes extending parallel to the longitudinal direction, in a plane parallel to an electrode width direction of the discharge electrodes; means for causing the injected seed light to pass through a substantially entire gain region between the discharge electrodes; and means for arranging one of the rear-side mirror and the output-side mirror orthogonal to an axis parallel to the longitudinal direction of the discharge electrodes, while arranging the other mirror such that laser light reflected thereby passes through the gain region.

According to an eighth aspect of the invention based on the seventh aspect of the invention, the means for arranging the other mirror such that laser light reflected thereby passes through the gain region is means for tilting the mirror with respect to the other mirror around an axis extending in a direction orthogonal to both of the optical axis of the discharge electrodes and the electrode width direction of the discharge electrodes.

The seventh and eighth aspects of the invention will be described with reference to FIG. 24.

As shown in FIG. 24, the rear-side mirror 21 is arranged orthogonal to the discharge electrode axis 32. On the other hand, the output-side mirror 22 is tilted at a tilt angle θ2 around an axis parallel to the discharge electrodes 24 and 25 so as to reflect laser light reaching the output-side mirror 22.

According to a ninth aspect of the invention based on the third aspect of the invention, the laser beam width enlarging means is means for arranging one of the rear-side mirror and the output-side mirror orthogonal to an axis extending along the longitudinal direction of the discharge electrodes, while arranging the other mirror such that laser light reflected thereby travels away from a gain region between the discharge electrodes.

According to the tenth aspect of the invention based on the ninth aspect of the invention, the means for arranging the mirror such that laser light reflected thereby travels away from the gain region between the discharge electrodes is means for tilting the mirror with respect to the other mirror around an axis orthogonal to both of the axis of the longitudinal direction of the discharge electrodes and the axis of an electrode width direction of the discharge electrodes.

The ninth and tenth aspects of the invention will be described with reference to FIG. 27.

As shown in FIG. 27, the rear-side mirror 21 is arranged orthogonal to the discharge electrode axis 32. The output-side mirror 22 is tilted at a tilt angle θ with respect to the rear-side mirror 21, around an axis of the discharge direction of the discharge electrodes 24 and 25 so as to reflect laser light reaching the output-side mirror 22.

According to an eleventh aspect of the invention based on the third aspect of the invention, the laser beam width enlarging means is means for injecting seed light generated by the oscillation stage laser into the laser chamber of the amplification stage laser such that the laser beam is spread in an electrode width direction of the discharge electrodes.

In the eleventh aspect of the invention as shown in FIG. 29, seed light generated by the oscillation stage laser (not shown) is injected into the resonator so as to be spread vertically on the sheet surface.

A laser beam deviated to the upper side of the drawing reaches the output-side mirror 22 at the tilt angle θ and then is reflected thereby. On the other hand, a laser beam deviated to the lower side of the drawing reaches the output-side mirror 22 at the tilt angle θ and is then reflected thereby. Accordingly, the width of the laser beams repeatedly reflected back and forth is gradually enlarged in the vertical direction in the drawing.

According to a twelfth aspect of the invention based on the third aspect of the invention, a beam expander is provided between the laser chamber of the amplification stage laser and the output-side mirror.

In the twelfth aspect of the invention as shown in FIG. 31, the laser chamber 23 and the beam expander 36 are arranged within the resonator comprised of the rear-side mirror 21 and the output-side mirror 22.

The laser beam width enlarging means according to any of the first to eleventh aspects of the invention is able to enlarge the laser beam width. Therefore, even if the laser output per pulse is higher than that in the prior art, the energy density applied to the optical elements provided in the laser chamber can be reduced, and hence deterioration of the windows can be suppressed.

In the case of the sixth aspect of the invention, since the seed light is allowed to pass through most of the gain region, deterioration of the windows can be suppressed and the discharge energy can be utilized effectively.

In the case of the seventh and eighth aspects of the invention, deterioration of the windows can be suppressed and the laser beam reflected back and forth within the resonator can be prevented from deviating from the gain region. Therefore, the discharge energy can be utilized effectively.

According to the twelfth aspect of the invention, deterioration of the windows can be suppressed and deterioration of the output-side mirror can be suppressed at the same time.

### BRIEF DESCRIPTION OF THE DRAWINGS

FIG. 1 is a conceptual diagram showing a two-stage laser system according to the present invention;

FIG. 2 shows experimental results indicating relation between an output energy and lifetime of optical elements in a MOPO laser system;

FIG. 3 is a conceptual diagram showing a case in which the discharge electrode width is enlarged;

FIG. 4A is a conceptual diagram for explaining configuration of a conventional excimer laser device, while FIG. 4B is a conceptual diagram for explaining configuration of a first embodiment of the present invention;

FIG. 5 is a diagram illustrating a diagonal angle θ1 determined by a length L in a longitudinal direction of discharge electrodes and a discharge electrode width T;

FIG. 6 is a diagram showing relation between a tilt angle θ, a laser beam width B, and an output energy P of laser light;

FIG. 7 is a model diagram for simulation of the first embodiment;

FIG. 8 is a model diagram for simulating a peak energy density and a laser beam width with respect to a gain length Lg;

FIG. 9 is a diagram showing a result of simulating the relation between gain length Lg and laser light output energy P by using the model of FIG. 8;

FIG. 10 is a diagram showing a result of simulating the relation between tilt angle θ of discharge electrodes and laser beam width B;

FIG. 11 is a diagram showing a result of simulating the relation of a peak energy density and a laser beam width with respect to a tilt angle;

FIG. 12A is a diagram showing configuration of a conventional amplification stage laser 20, FIG. 12B is a diagram showing configuration of an amplification stage laser 20 according to a second embodiment of the present invention, and FIG. 12C is a diagram showing a modification of the second embodiment;

FIG. 13 is a diagram showing experimental results in the second embodiment;

FIG. 14 is a conceptual diagram for explaining how a laser beam is shifted every time it is reflected in a resonator according to a third embodiment;

FIG. 15 is a conceptual diagram for further explaining how a laser beam is expanded in the third embodiment;

FIG. 16 is a diagram showing a mode in which the laser beam illustrated in FIG. 15 is reflected back and forth;

FIG. 17 is a model diagram showing a case in which a second pass of a laser beam is deviated from a gain region;

FIG. 18 is a diagram showing a summary of results of simulation conducted based on representative parameters;

FIG. 19 is a diagram showing gains Gp of first, second and third passes obtained by calculation using the model diagram of FIG. 17;

FIG. 20 is a diagram showing results of integrating the gains Gp of all the passes in the model diagram of FIG. 17;

FIG. 21A is a schematic diagram showing a conventional amplification stage laser 20, while FIG. 21B is a schematic diagram showing an amplification stage laser 20 according to the third embodiment;

FIG. 22 is a diagram showing experimental results in the third embodiment;

FIG. 23A is a diagram corresponding to FIG. 22B of the third embodiment, while FIG. 23B is a schematic diagram showing an amplification stage laser according to a fourth embodiment;

FIG. 24 is a conceptual diagram for explaining a fifth embodiment;

FIG. 25 is an enlarged view of the vicinity of an output-side mirror 22;

FIG. 26 is a diagram comparing experimental results in the fifth embodiment with the experimental results under conventional and novel condition shown in FIG. 2;

FIG. 27 is a conceptual diagram for explaining a sixth embodiment;

FIG. 28 is a conceptual diagram for explaining a reflection mode of a laser beam in a resonator according to the sixth embodiment;

FIG. 29 is a conceptual diagram for explaining a seventh embodiment;

FIG. 30A shows a case in which mirrors are arranged in a confocal manner, FIG. 30B a case in which mirrors are arranged in semi-confocal manner, FIG. 30C a case in which mirrors are arranged in a radial manner, and FIG. 30D a case in which a rear-side mirror 21 and an output-side mirror 22 are both formed of a triangular prism;

FIG. 31 is a conceptual diagram for explaining a ninth embodiment; and

FIG. 32A is a diagram for explaining a rear injection method, FIG. 32B is a diagram for explaining a side injection method, and FIG. 32C is a diagram for explaining a front injection method.

### DETAILED DESCRIPTION OF THE PREFERRED EMBODIMENTS

Preferred embodiments of the present invention will be described in detail with reference to the accompanying drawings.

First, the basic configuration and operation of an excimer laser device according to the present invention will be generally described using a two-stage laser system. The present invention is however applicable also to an excimer laser device having a single laser chamber, as described later in the description of the embodiments.

In the following description of the embodiments, the term “the sheet surface” means a plane parallel to a width direction of discharge electrodes in the drawings. When a rear-side mirror 21 and an output-side mirror 22 are arranged parallel to each other, the direction of a resonator optical axis 30 defined by the mirrors 21 and 22 is defined as a lateral direction on the sheet surface, while a direction orthogonal to the resonator optical axis 30 on the sheet surface is defined as a vertical direction. When the mirrors 21 and 22 are not parallel to each other, the direction of an axis (discharge electrode axis) 32 parallel to the longitudinal direction of discharge electrodes 24 and 25 is defined as a lateral direction on the sheet surface, while a direction orthogonal to the discharge electrode axis 32 on the sheet surface is defined as a vertical direction. It should be noted that, in the present invention, a tilt angle is always an angle as small as a few mrad. The tilt angle is always an angle formed in a plane parallel to the discharge electrode width direction.

### Two-Stage Laser System

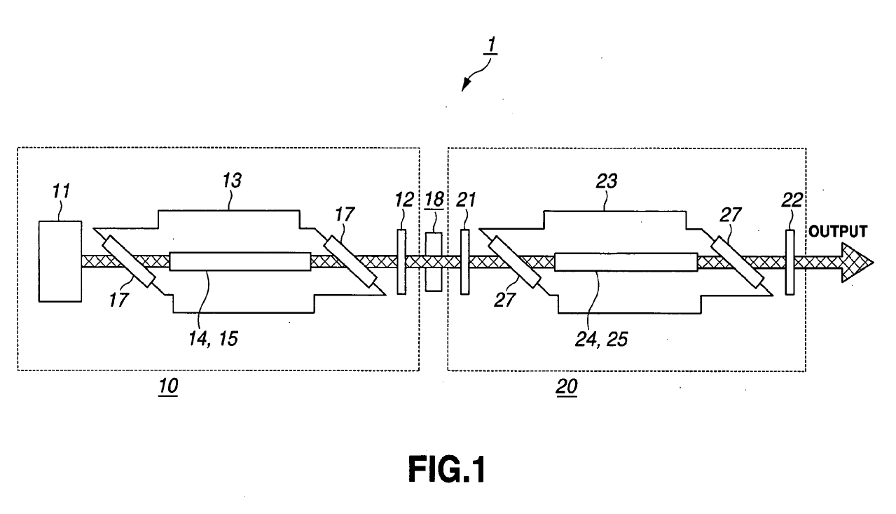

FIG. 1 is a conceptual diagram showing a two-stage laser system according to the present invention.

As shown in FIG. 1, a two-stage laser system 1 is a MOPO (master oscillator/power oscillator) system having a laser resonator in an amplification stage laser 20, and comprised of an oscillation stage laser (MO, or master oscillator) 10 and an amplification stage laser (PO, or power oscillator) 20 receiving seed light oscillated by the oscillation stage laser 10 and outputting laser light after amplifying the same.

The amplification stage laser 20 includes a Fabry-Perot etalon type resonator composed of a rear-side mirror 21 and an output-side mirror 22 both of which are of a flat type. A laser chamber 23 having laser gas sealed therein is arranged between the mirrors 21 and 22.

A pair of discharge electrodes 14 and 15 and another pair of discharge electrodes 24 and 25 are arranged in the respective laser chambers 13 and 23 of the oscillation stage laser 10 and the amplification stage laser 20. Windows 17, 17 and windows 27, 27 are provided on the laser optical axis of the discharge electrodes 14 and 15 and discharge electrodes 24 and 25 so as to be parallel with each other. The windows are formed from a material having permeability to laser oscillation light, such as CaF2. The windows 17, 17 and the windows 27, 27 are arranged at a Brewster angle to the laser light for decreasing the reflection loss.

The oscillation stage laser 10 includes a laser resonator comprised of a rear-side mirror in a narrowband module 11 and an output-side mirror 12. A laser chamber 13 having laser gas sealed therein is arranged between these mirrors. The narrowband module 11 is provided therein with a prism and a grating, for example, and the grating also functions as a mirror.

A laser light guide 18 is provided between the oscillation stage laser 10 and the amplification stage laser 20. The laser light guide 18 includes a plurality of laser light guide mirrors to guide seed light generated by the oscillation stage laser 10 to the amplification stage laser 20.

As shown in FIG. 1, each pair of the discharge electrodes 14 and 15 and the discharge electrodes 24 and 25 is arranged to face each other, on the front side and the rear side on the sheet surface. A high-voltage pulse is applied from a power source (not shown) to each pair of the discharge electrodes 14 and 15 and discharge electrodes 24 and 25, whereby electrical discharge is generated between the discharge electrodes 14 and 15 and between the discharge electrodes 24 and 25. The electrical discharge thus generated excites the laser gas between the discharge electrodes 14 and 15 and between the discharge electrodes 24 and 25. This means that spaces between the discharge electrodes 14 and 15 and the discharge electrodes 24 and 25 form gain regions. The laser optical axis extends along the longitudinal direction of the discharge electrodes 14 and 15 and the discharge electrodes 24 and 25, and the laser light energy is amplified every time the laser light passes across the gain region.

In the case of the MOPO system, the laser beam has an average energy density of several mJ/cm² in the oscillation stage laser 10, whereas the average energy density of the laser beam becomes several tens of mJ/cm² in the amplification stage laser 20. The energy density in the laser beam is not uniform. In general, the energy density is distributed to be higher in a central part of the beam and lower in the skirts of the beam. Therefore, a peak energy density is typically several times higher than the average energy density.

When the MOPO system is a KrF excimer laser device, a laser gas composed of krypton (Kr) gas, fluorine (F2) gas, and a buffer gas such as helium (He) or neon (Ne) is sealed in the respective laser chambers 13 and 23 of the oscillation stage lasers 10 and the amplification stage laser 20. When the MOPO system is an ArF excimer laser device, a laser gas composed of argon (Ar) gas, fluorine (F2) gas, and a buffer gas such as helium (He) or neon (Ne) is sealed in the respective laser chambers 13 and 23 of the oscillation stage laser 10 and the amplification stage laser 20.

The terms used herein in relation to the laser beam and the gain will be described.

The spectrum of the laser light output from the output-side mirror has distribution such that a peak energy density is present at a central portion and the energy density is decreased from the central portion towards the skirts. The term “laser beam width” as used in the present invention is defined as a region (width) having an energy density of 5% or more of the peak energy density. The term “average energy density” is defined as an average value of the energy density distribution within the laser beam width.

A value indicating how much the laser beam is amplified while passing through a unit distance (mm) in the gain region is denoted by G0. That is, G0 denotes an amplification factor per unit distance of the gain region.

### First Embodiment

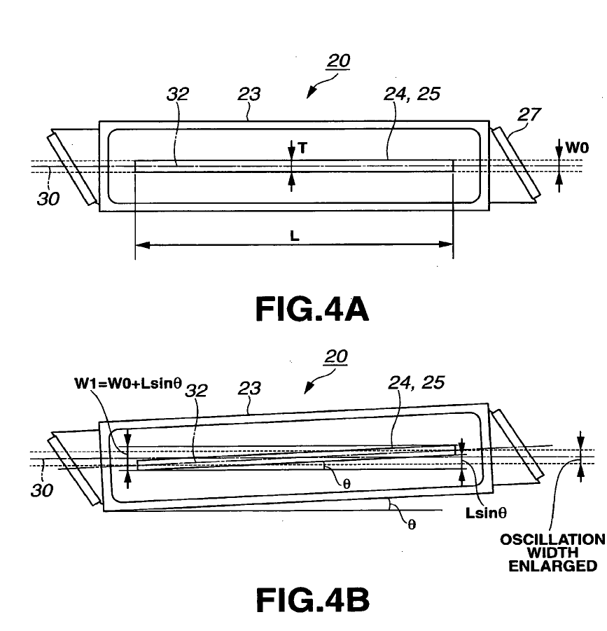

FIG. 4A is a conceptual diagram for explaining configuration of a conventional excimer laser device. FIG. 4B is a conceptual diagram for explaining configuration of a first embodiment of the present invention. Although common reference numerals with those of the amplification stage laser 20 in FIG. 1 are used in FIGS. 4A and 4B for convenience of explanation, the use of the common reference numerals simply means that those components are equivalent in function. The components bearing these reference numerals are not limited to the amplification stage laser 20 but may be applied to a single-chamber excimer laser device as well.

In the conventional excimer laser device as shown in FIG. 4A, the resonator optical axis 30 is parallel to the axes in the longitudinal direction of the discharge electrodes 24 and 25 provided in the laser chamber. Therefore, a gain region width W0 in the vertical direction in the paper sheet as viewed from the side of the resonator optical axis 30 is the same as an electrode width T of the discharge electrodes. This means that the oscillation width is equivalent to the gain region width W0.

In contrast, in the excimer laser device according to the first embodiment as shown in FIG. 4B, the discharge electrode axis 32 of the discharge electrodes 24 and 25 is tilted at a tilt angle θ with respect to the resonator optical axis 30.

When a length in the longitudinal direction of the discharge electrodes 24 and 25 is denoted by L, and a gain region width as viewed from the side of the resonator optical axis 30 is denoted by W1, the gain region width W1 can be approximately represented by the equation W1=W0+L sin θ. In other words, the gain region width can be enlarged by L sin θ in comparison with the conventional configuration. Since the gain region width as viewed from the side of the resonator optical axis 30 can be enlarged, the oscillation width in the resonator can be enlarged.

As the tilt angle θ of the discharge electrode axis 32 is increased, the distance for which the laser beam is allowed to travel in the gain region is decreased. This means that, if the tilt angle θ becomes too large, the laser beam that is reflected back and forth within the resonator will possibly not be amplified effectively in the gain region.

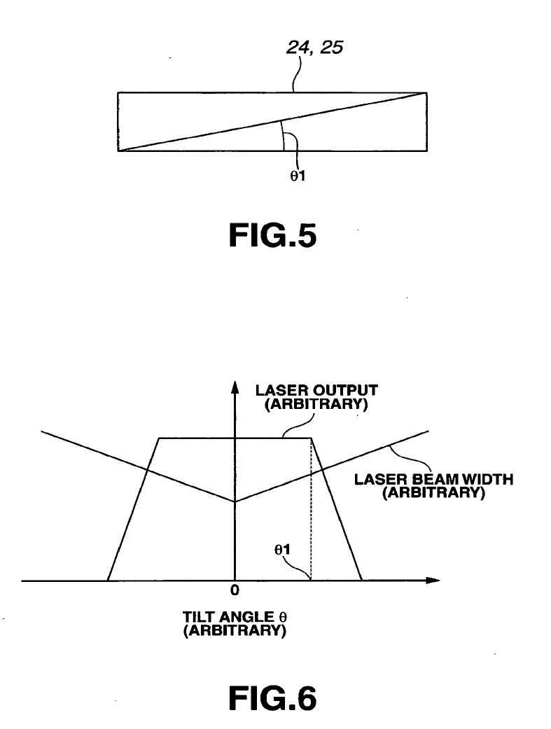

According to experiment results, if the gain G0 and the injected light amount are both high, the output energy can be held substantially constant until the tilt angle becomes a diagonal angle θ1 of the discharge electrodes 24 and 25 shown in FIG. 5. However, once the tilt angle exceeds θ1, the output energy rapidly drops.

FIG. 6 is a diagram showing relation between the tilt angle θ, the laser beam width B and the output energy P of laser light.

The horizontal axis represents the tilt angle θ of the discharge electrode 32, and the vertical axis represents the laser beam width B (arbitrary) or the laser output P (arbitrary). As seen from the configuration shown in FIG. 4B, the laser beam width and the laser output are symmetrical between the positive and negative tilt angles θ of the discharge electrode axis 32.

As seen from FIG. 6, the laser beam width B monotonically increases along with the tilt angle θ. On the other hand, the output energy P of the laser light does not vary even if the tilt angle θ is increased to some extent, on the condition that the gain G0 is high and the light amount of injected seed light is also high. However, once the tilt angle θ exceeds the diagonal angle θ1 shown in FIG. 5, the output energy of the laser light rapidly drops.

Although a desired laser output cannot be obtained if the tilt angle θ of the discharge electrodes is too large, the laser beam width can be enlarged while maintaining the output energy of the laser light substantially constant as long as the tilt angle θ is smaller than the diagonal angle θ1. Consequently, the laser beam illuminated area of the optical elements arranged in the resonator can be enlarged.

According to the first embodiment as described above, the laser beam width is enlarged such that the energy density of the laser beam applied to the optical elements provided in the laser chamber is decreased within such a range that no less than desired output energy of the laser light is obtained. This makes it possible to suppress deterioration of the optical elements provided in the laser chamber even if the output energy per pulse is increased more than the prior art without changing the discharge electrode width.

### Simulation by Calculation

The description so far does not take into account the magnitude of the gain G0 or the magnitude of the injected light amount. The following description will show simulation results calculated by additionally using the gain G0 and the injected light amount as parameters.

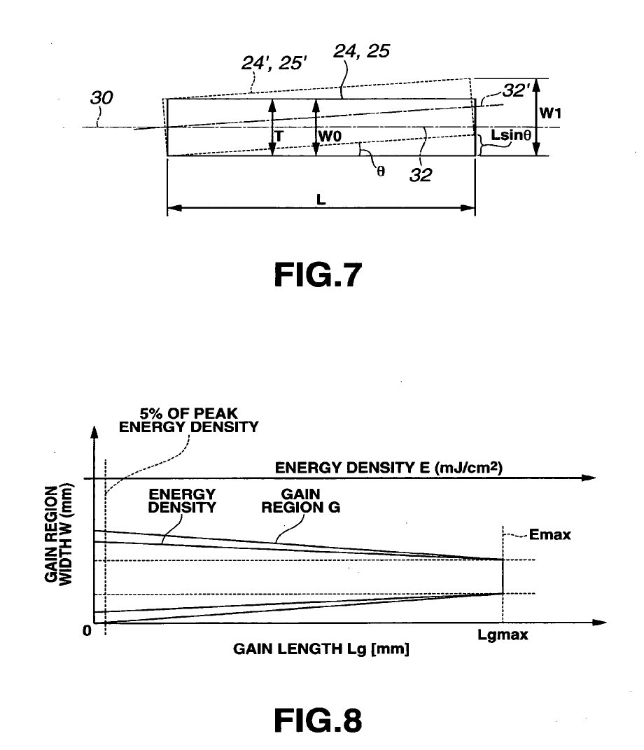

FIG. 7 is a model diagram for simulation of the first embodiment based on FIG. 4B.

As seen from FIG. 7, the discharge electrode axis 32 of the prior art is parallel to the resonator optical axis 30. The gain region width W0 as viewed from the direction of the resonator optical axis 30 is the same as the discharge electrode width T.

In contrast, the discharge electrode axis 32′ of the first embodiment is tilted at a tilt angle θ with respect to the resonator optical axis 30. When the length in the longitudinal direction of the discharge electrodes is denoted by L, the gain region width W1 as viewed from the direction of the resonator optical axis 30 is approximately represented by the equation W1=W0+L sin θ. Thus, the gain width as viewed from the direction of the resonator optical axis 30 is enlarged by L sin θ. In principle, the gain width is greater than the laser beam width.

FIG. 8 is a model diagram for simulation of the peak energy density and the laser beam width with respect to the gain length Lg. The horizontal axis represents the gain length Lg. The vertical axis represents the gain region width W which is determined by a tilt angle θ. A peak energy density Ep and a laser beam width B are simulated with respect to a set gain region G.

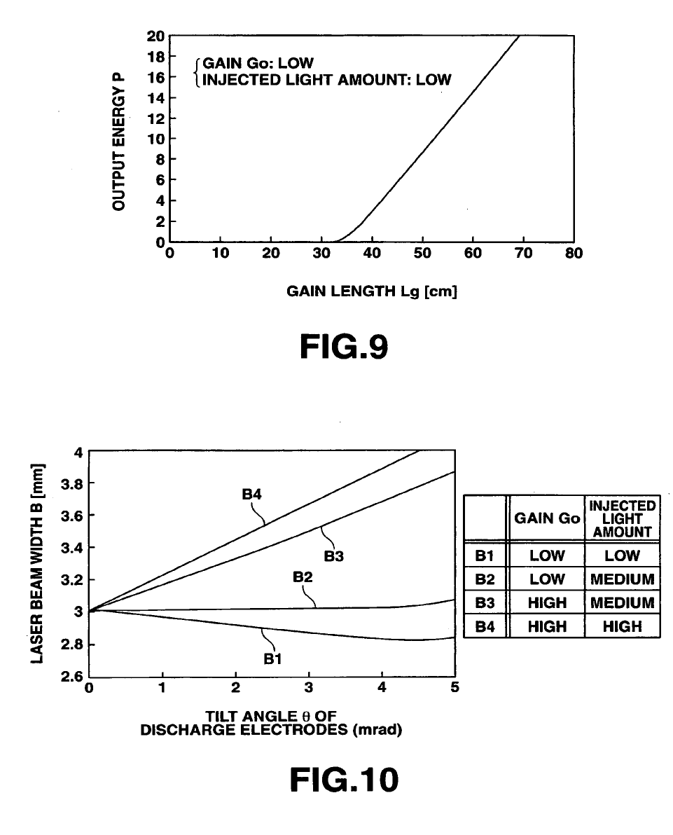

FIG. 9 is a diagram showing results of simulating the relation between the gain length Lg and the laser light output energy P using the model shown in FIG. 7. The simulation was performed with the gain G0 set low (relative value) and the injection energy of the seed light to the amplification stage laser set low (relative value). The discharge electrode width was 3 mm.

According to FIG. 9, the output energy P is zero when the gain length Lg is about 330 mm or less. When the gain length Lg exceeds 330 mm, the output energy P increases monotonically. For example, the output energy P is about 20 mJ when the gain length Lg is 700 mm. This means that the laser light output energy P becomes higher as the gain length Lg is longer.

FIG. 10 shows simulation results representing the relation between the tilt angle θ of the discharge electrodes and the laser beam width B. In consideration of FIG. 8, however, the discharge electrode length L was set to 700 mm, and the electrode width T was set to 3 mm. The horizontal axis represents the tilt angle θ (mrad) of the discharge electrodes, and the vertical axis represents the laser beam width B (mm).

According to FIG. 10, in the case of B1 (when the gain G0 is low and the injection energy is low), the laser beam width is decreased as the tilt angle θ of the discharge electrodes becomes greater. In the case of B4 (when the gain G0 is high and the injection energy is high), the laser beam width is increased as the tilt angle θ of the discharge electrodes becomes greater. This means that, according to FIG. 9, the laser beam width can be efficiently enlarged by increasing the gain G0 and the injection energy.

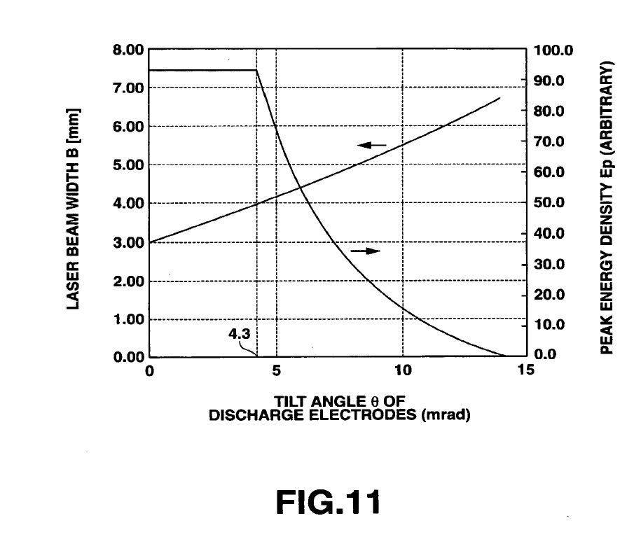

FIG. 11 shows simulation results representing the relation between the peak energy density and the laser beam width with respect to the tilt angle. In this simulation, the parameters of B4 in FIG. 10 were used as optimal condition. The horizontal axis represents the tilt angle θ (mrad) of the discharge electrodes, and the right side of the vertical axis represents the peak energy density Ep (arbitrary unit), while the left side represents the laser beam width B (mm). The discharge electrode length L was set to 700 mm, and the electrode width T of the discharge electrodes was set to 3 mm. Accordingly, the diagonal angle θ1 is 4.3 mrad.

According to FIG. 11, the laser beam width B is increased as the tilt angle θ becomes greater. When the tilt angle θ is in the range of 0 to 5 mrad, the laser beam width B is increased from 3 mm to 4 mm. Thus, the enlargement factor of the laser beam width B is (4.2−3)/(5−0) mm/mrad=0.24 mm/mrad. On the other hand, the peak energy density Ep remains fixed until the tilt angle θ becomes 4.3 mrad. Once the tilt angle θ exceeds 4.3 mrad, the peak energy density rapidly drops. This means that the gain in a central portion of the gain region is rapidly decreased when the tilt angle becomes 4.3 mrad or greater. Therefore, it can be seen that the tilt angle at which the peak energy density drops is an angle around the diagonal angle θ1.

According to FIG. 11, when the tilt angle θ is 4.3 mrad, the laser beam width B is about 4 mm in comparison with the original laser beam width of 3 mm. It can be seen, according to the simulation above, that the laser beam width B can be enlarged by about 1 mm compared to the original laser beam width without decreasing the laser output. In terms of calculation, the laser beam width B is enlarged 33%.

Accordingly, the width B of the laser beam applied to the window can be enlarged 33% compared to the prior art even if the laser light output energy is increased 33% compared to the prior art. It is therefore possible, in calculation, to decrease the energy density of the laser light applied to the window to an equivalent level or lower compared to the prior art.

As described above, the simulation results also reveal that the laser beam width can be enlarged by the enlargement of the gain width. A specific value of the tilt angle θcan be obtained by simulation, and such value can be used as a guideline for performing experiments.

### Second Embodiment

The description of the first embodiment has not specifically mentioned the resonator forming the resonator optical axis 30.

A second embodiment of the present invention assumes the amplification stage laser 20 of the two-stage laser system 1 shown in FIG. 1.

In the second embodiment, the axis in the longitudinal direction of the discharge electrodes is tilted with respect to a resonator optical axis formed by arranging a rear-side mirror 21 and an output-side mirror 22 parallel to each other.

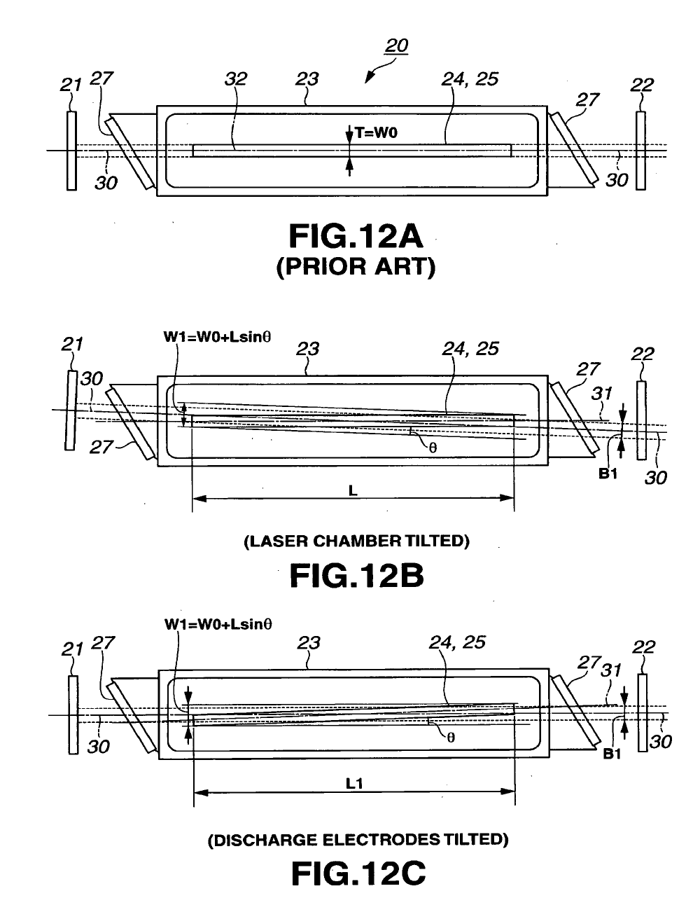

FIG. 12A is a diagram showing configuration of a conventional amplification stage laser 20. FIG. 12B is a diagram showing configuration of an amplification stage laser 20 according to the second embodiment. FIG. 12C shows a modification of the second embodiment.

In FIGS. 12A, 12B and 12C, the rear-side mirror 21 and the output-side mirror 22 are arranged in the amplification stage laser 20 parallel to each other, forming the resonator optical axis 30.

As shown in FIG. 12A, a discharge electrode axis 32 parallel to the longitudinal direction of discharge electrodes 24 and 25 arranged inside a resonator is parallel to the resonator optical axis 30. Therefore, in the case of the conventional amplification stage laser 20, the discharge electrode width T of the discharge electrodes 24 and 25 matches a gain region width W0 as viewed from the direction of the resonator optical axis 30.

In contrast, according to the second embodiment as shown in FIG. 12B, the discharge electrode axis 32 of the discharge electrodes 24 and 25 is tilted at a tilt angle θ with respect to the resonator optical axis 30 on the sheet surface. The discharge electrode axis 32 can be tilted in this manner by rotating the laser chamber 23 anti-clockwise on the sheet surface.

According to FIG. 12B, the laser chamber 23 is tilted around a rotation axis that is arbitrarily set with respect to the resonator optical axis 30, whereby the gain region of the discharge electrodes 24 and 25 is also tilted together. Therefore, when the discharge electrode is denoted by L, a gain region width W1 as viewed from the direction of the resonator optical axis 30 is approximately represented by the equation, W1=W0+L sin θ, which means that the gain region width W1 is enlarged by L sin θ in the vertical direction on the sheet surface orthogonal to the resonator optical axis 30.

Since the gain region width is enlarged by L sin θ, the width of a laser beam oscillated (amplified) in the resonator is also enlarged in the vertical direction on the sheet surface orthogonal to the resonator optical axis 30. The enlarged laser beam width is denoted by B1. The laser beam width B1 is smaller than the enlarged gain region width W1. That is, W1>B1.

According to the second embodiment as described above, the laser beam width is also enlarged along with the enlargement of the gain region width. Therefore, the energy density of a laser beam applied to windows 27, 27 provided in the laser chamber 23 can be reduced.

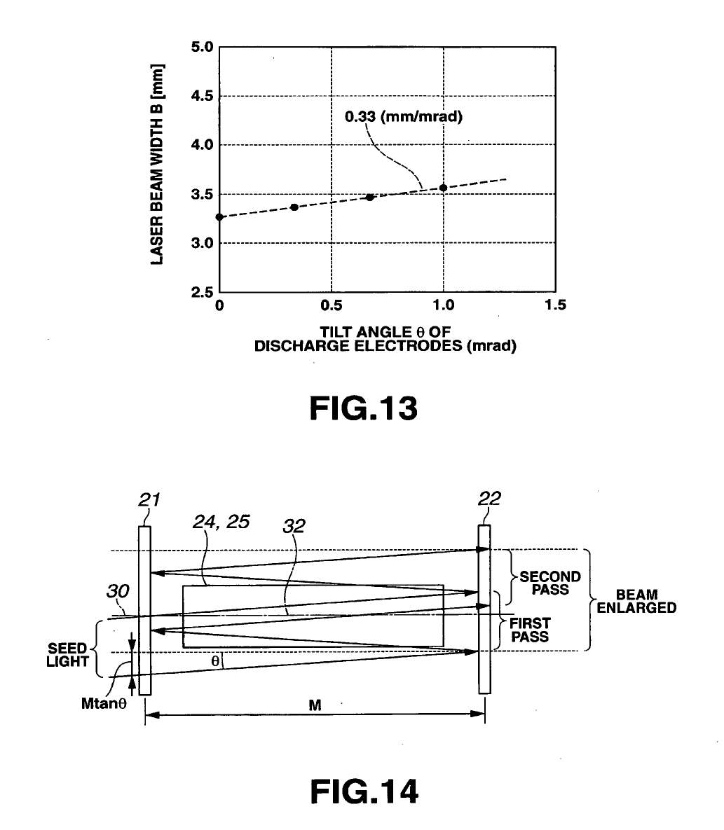

FIG. 13 is a diagram showing experimental results in the second embodiment. The horizontal axis represents the tilt angle θ (mrad), and the vertical axis represents the laser beam width B (mm).

According to FIG. 13, the enlargement factor of the laser beam width B is about 0.33 mm/mrad, that is slightly greater than the enlargement factor of 0.24 mm/mrad in the simulation described above. Accordingly, in the second embodiment, the laser beam width can be enlarged by one mm by setting the tilt angle θ to about 3 mrad.

FIG. 12C shows a modification of the second embodiment.

In FIG. 12C, unlike the configuration shown in FIG. 12B, the laser chamber 23 is fixed and only the discharge electrodes 24 and 25 in the laser chamber 23 are moved so that the discharge electrode axis 32 is tilted at a tilt angle θ with respect to the resonator optical axis 30.

As is obvious from FIG. 12C, as long as the positional relationship between the resonator optical axis 30 and the discharge electrode axis 32 is concerned, it is entirely the same as that of FIG. 12B. Accordingly, the effects obtained thereby are also the same as those of FIG. 12B. The description of the modification will thus be omitted.

Although the description of the second embodiment has been so far made using the amplification stage laser of the two-stage laser system, the invention of the second embodiment is also applicable to a single laser chamber.

Although in FIGS. 12B and 12C, the laser chamber or the discharge electrodes are rotated anti-clockwise on the sheet surface, it should be understood that the laser chamber or the discharge electrodes may be rotated clockwise on the sheet surface.

According to the second embodiment as described above, either in the amplification stage of the two-stage laser system or in the single-chamber excimer laser device, the laser beam width can be set to reduce the energy density of a laser beam applied to the windows within such a range that a laser output of no less than a desired level is obtained.

Accordingly, even if the output energy per pulse is increased more than the prior art, the laser beam width can be enlarged to reduce the energy density of the laser beam applied to the optical elements.

This makes it possible to suppress deterioration of the optical element provided in the laser chamber even if the output energy per pulse is increased more than the prior art.

### Third Embodiment

A third embodiment of the present invention is applicable to a MOPO system using seed light.

### Basic Principle and Simulation of Third Embodiment

A basic principle and simulation results of the third embodiment will be described.

FIG. 14 is a conceptual diagram for explaining how a laser beam is shifted at every reflection in the resonator according to the third embodiment.

A rear-side mirror 21 and an output-side mirror 22 are arranged in an amplification stage laser 20 parallel to each other, forming a resonator optical axis 30. A discharge electrode axis 32 is parallel to the resonator optical axis 30.

In the configuration described above, seed light is injected at a tilt angle θ with respect to the resonator optical axis 30 and reaches the output-side mirror 22 (this pass is referred as the “first pass”). When a distance between the rear-side mirror 21 and the output-side mirror 22 is denoted by M, the injected seed light will be shifted to the upper side in the drawing by M tan θ while the seed light travels from the rear-side mirror 21 to reach the output-side mirror 22. The laser beam reflected by the output-side mirror 22 at a reflection angle θ reaches the rear-side mirror 21. The laser beam is further shifted to the upper side in the drawing by M tan θ while traveling to reach the rear-side mirror 21. The laser beam reflected by the rear-side mirror 21 at the reflection angle θ reaches the output-side mirror 22 (this pass is referred to as the “second pass”). From then on, the reflection in the resonator is repeated similarly at a fixed reflection angle θ, and the laser beam is shifted to the upper side in the drawing by M tan θ at every reflection.

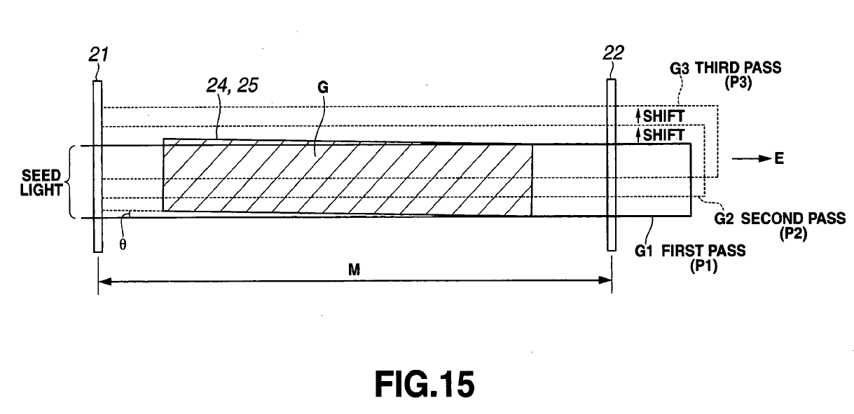

FIG. 15 is a conceptual diagram for further explaining how the laser beam is enlarged according to the third embodiment.

In FIG. 15, a central shaded area indicates a gain region G of the discharge electrodes 24 and 25. Seed light (a laser beam) injected from the rear-side mirror 21 passes through most of the gain region G at a tilt angle θ with respect to the resonator optical axis 30 and reaches the output-side mirror 22 (the first pass). The laser beam in the first pass is shifted to the upper side in the drawing by M tan θ with respect to the injected laser beam.

Part of the laser beam reaching the output-side mirror 22 is emitted through the output-side mirror 22 in the direction indicated by the arrow E as first-pass output energy P1. An image of the first-pass laser beam is indicated by a region G1.

Most of the laser beam reaching the output-side mirror 22 is reflected at the reflection angle θ, again passes through the gain region G, and reaches the rear-side mirror 21 after being amplified. The laser beam reaching the rear-side mirror 21 is reflected at the reflection angle θ, again passes through the gain region G, and reaches the output-side mirror 22 after being amplified (second pass). The second-pass laser beam is shifted to the upper side in the drawing by 3M tan θ with respect to the injected laser beam.

Part of the laser beam reaching the output-side mirror 22 is emitted through the output-side mirror 22 in the direction indicated by the arrow E as second-pass output energy P2. An image of the second-pass laser beam is indicated by a region G2.

Most of the laser beam reaching the output-side mirror 22 is reflected at the reflection angle θ, again passes through the gain region G, and reaches the rear-side mirror 21 after being amplified. The laser beam reaching the rear-side mirror 21 is reflected at the tilt angle θ, again passes through the gain region G, and reaches the output-side mirror 22 after being amplified (third pass). The third-pass laser beam is shifted to the upper side in the drawing by 5M tan θ with respect to the injected laser beam.

Part of the laser beam reaching the output-side mirror 22 is emitted through the output-side mirror 22 in the direction indicated by the arrow E as third-pass output energy P3. An image of the third-pass laser beam is indicated by a region G3. Subsequently, a similar event is repeated.

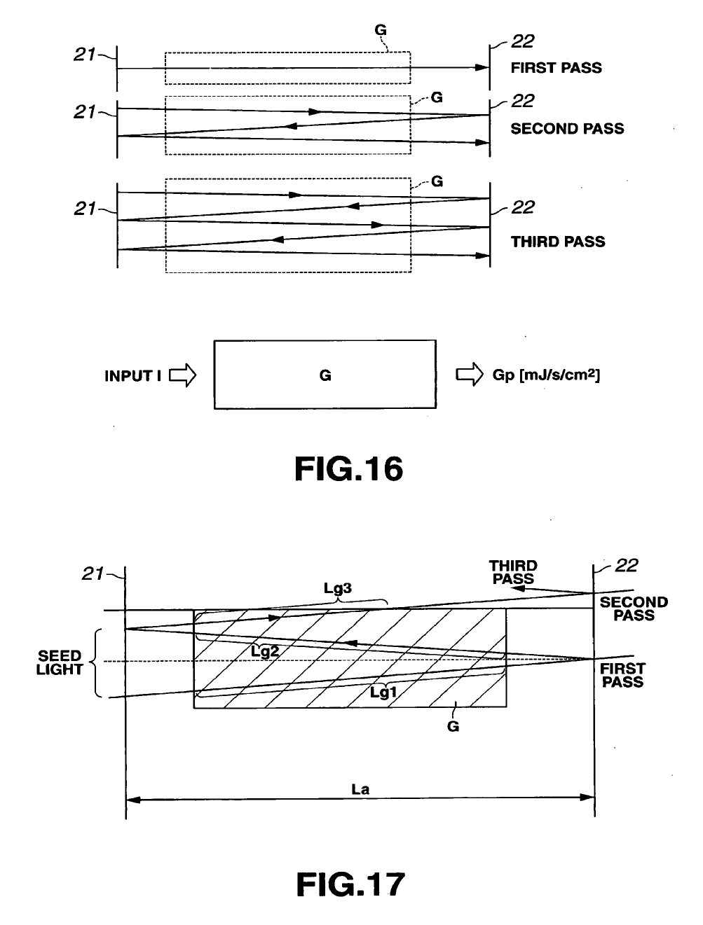

FIG. 16 is a diagram showing a mode in which the laser beam is reflected back and forth as described with reference to FIG. 15.

As shown in FIG. 16, the first-pass laser beam reaches the output-side mirror 22 after being amplified in the gain region G. This means that the first-pass laser beam passes through the gain region G once. The second-pass laser beam passes the gain region G three times. The third-pass laser beam passes through the gain region G five times.

The lower part of FIG. 16 illustrates a gain Gp representing an amplification factor for the laser beam when the laser beam passes through the gain region G a plurality of times.

The gain Gp represents an increasing rate at which the laser beam is amplified while passing through the gain region G, and is determined depending upon how the laser beam passes through the gain region. As the gain Gp is greater, the amplification factor becomes higher and the output of the laser light becomes higher. The gain Gp becomes smaller as the laser beam is further away from the gain region G (or as the passage passing through the gain region G is shorter). Therefore, the simulation was performed on the assumption that the position where the gain Gp becomes 0.35 or higher is the position where the peak energy density becomes 5% or higher. This means that the range (width) in which gain Gp 0.35 is higher corresponds to the laser beam width.

FIG. 17 is a model diagram showing a case in which the second-pass laser beam is deviated from the gain region.

As shown in FIG. 17, seed light injected into the laser chamber 23 at a tilt angle θ passes through the gain region G indicated by the shaded area, and reaches and is reflected by the output-side mirror 22. A gain length for which the laser beam passes through the gain region during this pass is indicated by Lg1. The reflected laser beam passes through the gain region to reach the rear-side mirror 21 and is reflected thereby. A gain length for which the laser beam passes through the gain region during this pass is indicated by Lg2. The reflected laser beam passes through the gain region to reach the output-side mirror 22 and is reflected thereby. A gain length for which the laser beam passes through the gain region during this pass is indicated by Lg3. After the third pass, the laser beam does not pass through the gain region and is not amplified. The space other than the gain region is referred to as the “loss region” of the laser beam. In the loss region, the laser light energy is only lost. The gain lengths Lg1, Lg2 and Lg3 can be determined using the tilt angle θ as a parameter.

It is assumed here that the energy loss per unit length is fixed. Therefore, an absorption length La in each pass is the same as the resonator length.

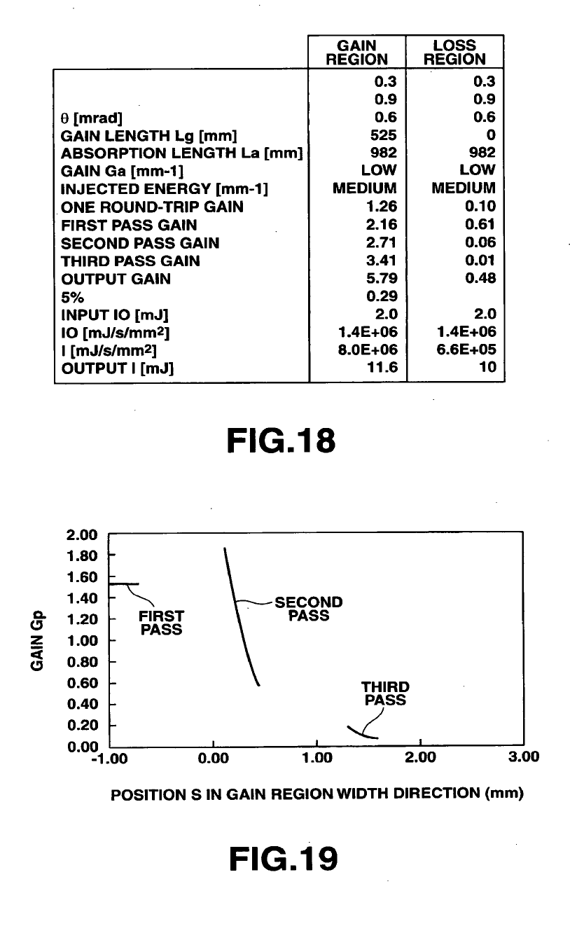

FIG. 18 is a table showing, in summary, the results of simulation performed based on representative parameters.

In FIG. 18, the gain G0 is set low and the injection energy is set medium. According to FIG. 18, the first-pass gain Gp is 2.16, the second-pass gain Gp is 2.71, the third-pass gain Gp is 3.41, and the output gain Gp is 5.79. The output is increased to 11.6 mJ compared to the input of 2 mJ.

FIG. 19 is a diagram showing the first-pass, second-pass, and third-pass gains Gp obtained by calculation using the model diagram of FIG. 17. The horizontal axis represents position S (mm) in the width direction of the gain region, while the vertical axis represents the gain Gp (value) in each pass.

As shown in FIG. 19, the first-pass and second-pass gains are high, whereas the third-pass gain is decreased due to high loss. It can be seen that the laser beam is shifted in the positive direction of the width of the gain region at every repeated pass. In other words, the laser beam width is enlarged.

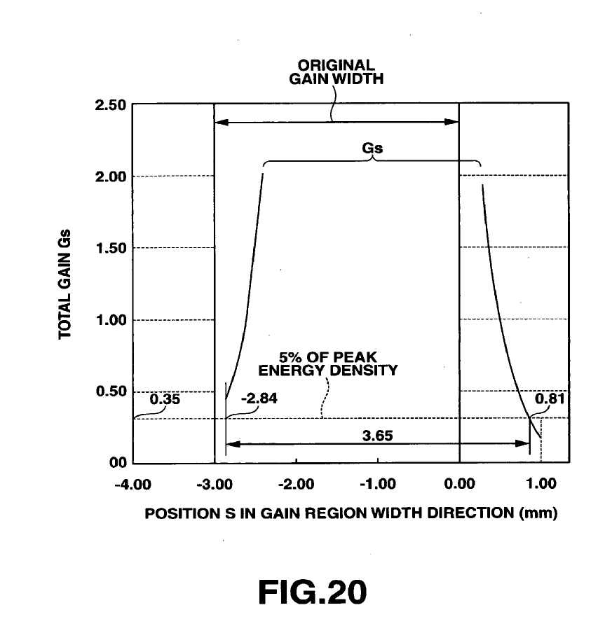

FIG. 20 is a diagram showing results of integrating the gains Gp of all the passes in the model diagram of FIG. 17.

The horizontal axis in FIG. 20 represents the position S (mm) in the width direction of the gain region, while the vertical axis represents the total gain Gs (value). The tilt angle of seed light is set to 0.6 mrad, the discharge electrode width is set to 3 mm, the absorption length is set to 982 mm, and the gain length Lg is set to 525 mm. The conventional gain region width is set between −3 to 0 mm.

The total gain Gs has a same shape as the spectrum of the output laser. According to FIG. 19, the range in which the gain is 0.35 or more is from −2.84 to 0.81 mm. This means that the laser beam width is 3.65 mm and is enlarged by 0.65 mm compared to the original gain region width 3 mm.

According to FIGS. 14 to 20 as described above, it is expected that the laser beam width can be enlarged by injecting the seed light at a tilt to the amplification stage laser 20. The injection angle θ of the seed light can take either a positive or negative value.

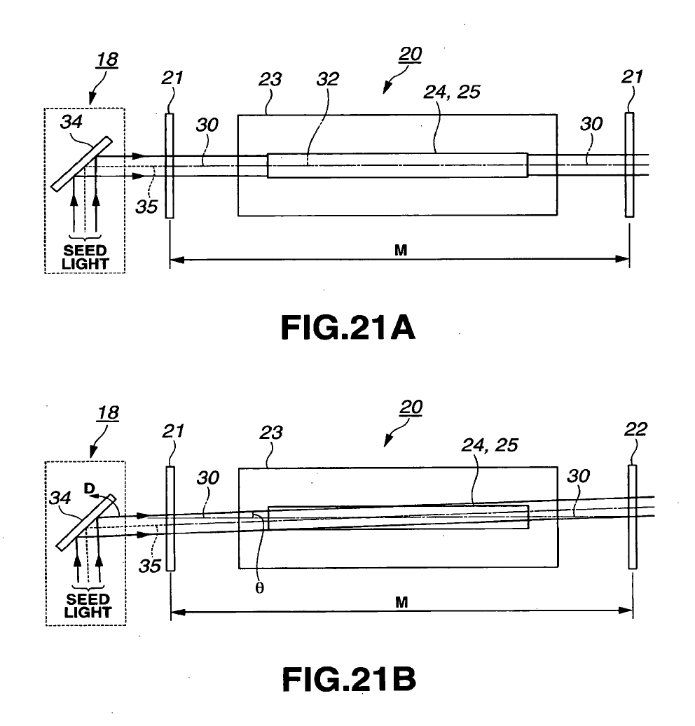

FIG. 21A is a diagram showing configuration of a conventional amplification stage laser 20. FIG. 21B is a diagram showing configuration of an amplification stage laser 20 according to the third embodiment of the present invention.

In the configuration of FIG. 21A, a rear-side mirror 21 and an output-side mirror 22 are arranged in the amplification stage laser 20 parallel to each other, forming a resonator optical axis 30.

Seed light generated by an oscillation stage laser (not shown) is guided by a laser light guide mirror 34 in a laser light guide 18, and injected into an amplification stage laser chamber 23 in parallel with the discharge electrode axis 32. This means that the optical axis 35 of the injected seed light is parallel to the resonator optical axis 30.

In contrast, in the case of the third embodiment, as shown in FIG. 21B, the seed light is injected such that the optical axis 35 of the injected seed light makes an injection angle θ (>0) with respect to the resonator optical axis 30 of the amplification stage laser 20. The optical axis 35 of the injected seed light can be tilted by rotating the laser light guide mirror 34 anti-clockwise (in the direction indicated by the arrow D in FIG. 21B) around an axis parallel to the discharge direction of the discharge electrodes 24 and 25.

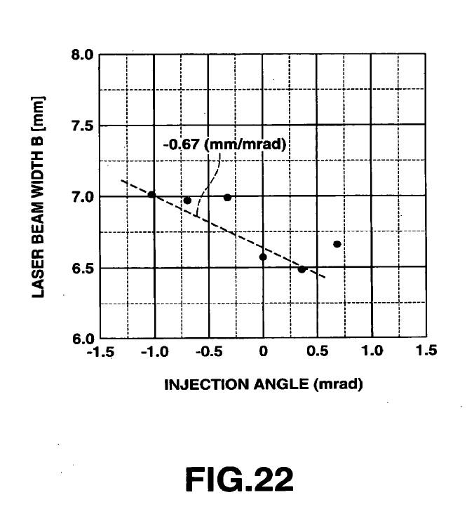

FIG. 22 is a diagram showing experimental results in the third embodiment. The horizontal axis represents the injection angle θ of seed light, and the vertical axis represents the laser beam width B (mm).

According to FIG. 22, it can be seen that the enlargement factor of the laser beam width is about 0.67 mm/mrad when the injection angle θ is changed to the negative side. Therefore, when the tilt angle is 0.6 mrad, for example, the laser beam width W can be enlarged by about 0.4 mm.

According to the third embodiment as described above, the laser beam width can be enlarged by injecting the seed light generated by the oscillation stage laser into the amplification stage laser 20 while making an angle with respect to the resonator optical axis 30.

Consequently, the energy density of the laser beam applied to the windows of the amplification stage laser chamber can be decreased even if the output energy per pulse is increased more than the prior art. This makes it possible to suppress deterioration of the windows provided in the amplification stage laser chamber.

Although the laser light guide mirror 35 is rotated anti-clockwise in FIG. 21B, the laser light guide mirror 35 may be rotated clockwise.

In the case of the third embodiment, laser light output from the output-side mirror 22 is tilted at the tilt angle θ with respect to the resonator optical axis 30, the tilt angle can be corrected while the laser light travels to reach the exit of the excimer laser device.

### Fourth Embodiment

A fourth embodiment of the present invention is applicable to a MOPO system using seed light.

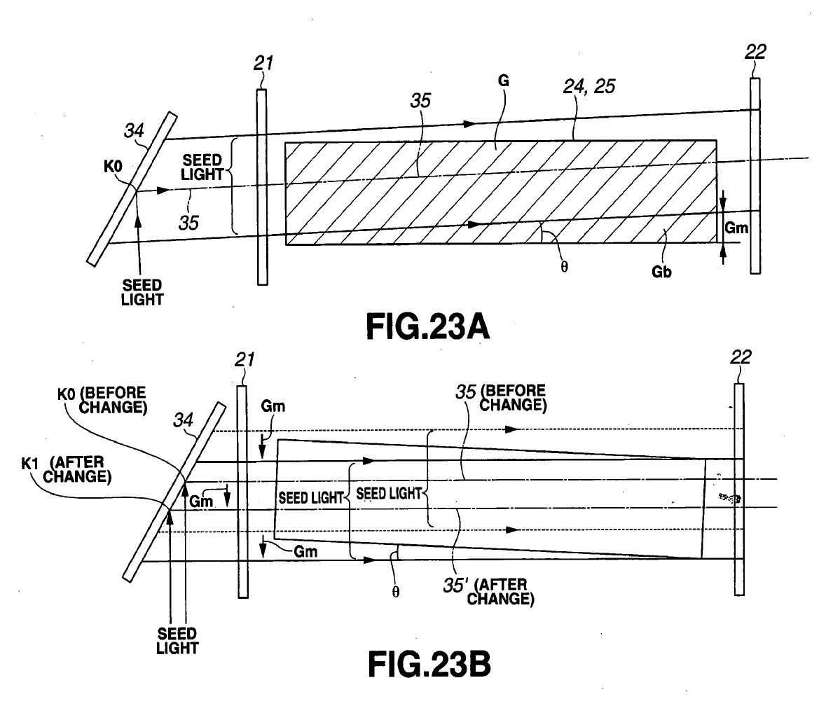

FIG. 23A is a diagram corresponding to FIG. 21B of the third embodiment. FIG. 23B is a schematic diagram showing an amplification stage laser according to the fourth embodiment.

In FIG. 23A, the laser light guide mirror 34 is adjusted to tilt the optical axis 35 of the injected seed light at a tilt angle θ with respect to the resonator optical axis 30. A position where the optical axis 35 of the injected seed light is reflected by the laser light guide mirror 34 is denoted by K0. In the case of FIG. 23A, the injected seed light of the first pass passes most of the gain region G indicated by the shaded area, except a partial region Gb in the gain region G. No laser light subsequently reflected back and forth will pass through this partial region Gb, and the discharge energy of the partial region Gb cannot be utilized to amplify (oscillate) the laser light. A maximum length of the partial region Gb in the vertical direction orthogonal to the resonator optical axis 30 on the sheet surface is denoted by Gm.

In the fourth embodiment as shown in FIG. 23B, the seed light position is shifted from the position indicated by the broken lines to the lower side in the drawing by Gm, to the position indicated by the solid lines, so that the injected seed light is able to pass through the partial region Gb.

Specifically, in order to shift the optical axis 35 of the injected seed light to the lower side in the drawing by Gm, the position where the optical axis of the seed light is reflected by the laser light guide mirror 34 is changed from the position K0 to the position K1. The change of the reflection position from K0 to K1 shifts the optical axis 35 of the injected seed light to the lower side in the drawing by Gm. The optical axis of the injected seed light thus changed is denoted by 35′.

According to calculation, when the tilt angle of the seed light is 0.6 mrad, for example, Gm is 0.43 mm. In this case, therefore, the injection optical axis 35 may be shifted to the lower side in the drawing by 0.43 mm. The reflection position K1 of the laser light guide mirror 34 for shifting the injection optical axis 35 to the lower side in the drawing by 0.43 mm can be found by experiments.

According to the fourth embodiment as described above, the laser light can be caused to pass through the entire gain region G by shifting the optical axis 35 of the injected seed light to the lower side in the drawing by a predetermined distance. Therefore, the discharge energy of the entire gain region G can be utilized for amplification of the laser light.

This makes it possible to utilize the discharge energy more effectively than in the third embodiment, while obtaining the advantageous effects of the third embodiment.

### Fifth Embodiment

A fifth embodiment of the present invention is applicable to a MOPO system using seed light.

In the case of FIG. 23B of the fourth embodiment, the entire gain region G is effectively utilized. However, the laser beam reaching the output-side mirror 22 is reflected at a reflection angle θ that is the same as the injection angle θ since the output-side mirror 22 and the rear-side mirror 21 are arranged parallel to each other. Therefore, the laser beam that is repeatedly reflected back and forth within the resonator is gradually shifted to a direction (upwards in the drawing) away from the gain region G. This means that the laser beam cannot be amplified effectively in the gain region G when the number of reflections becomes too large.

In the fifth embodiment, therefore, configuration is such that the entire gain region can be effectively utilized and the laser beam that is reflected back and forth within the resonator is prevented from moving away from the gain region G.

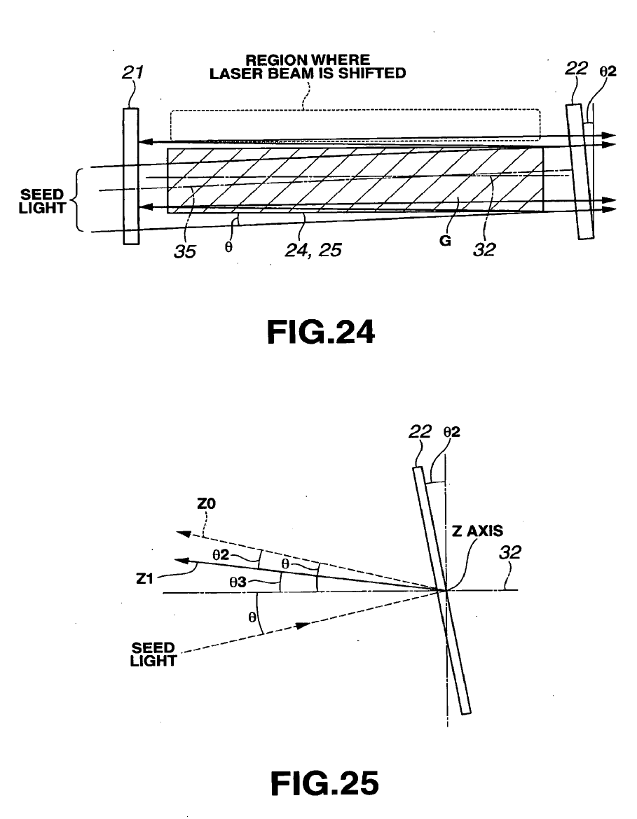

FIG. 24 is a conceptual diagram for explaining the fifth embodiment.

In the case of FIG. 24, like FIG. 23B, the optical axis 35 of injected seed light is arranged to make a tilt angle θ with respect to the discharge electrode axis 32. Further, the position of the injection optical axis 35 is optimized so as to enable effective utilization of the entire gain.

What is different from FIG. 23B is arrangement of the rear-side mirror 21 and the output-side mirror 22 forming a resonator.

As shown in FIG. 24, the rear-side mirror 21 is arranged orthogonal to the discharge electrode axis 32. On the other hand, the output-side mirror 22 is tilted at a tilt angle θ2 around an axis parallel to the discharge electrodes 24 and 25 so as to reflect the laser light reaching the output-side mirror 22. Such configuration makes it possible to prevent the laser beam reflected back and forth within the resonator from being shifted to the region indicated by the broken lines in the upper part of the drawing.

If the tilt angle θ of the injection optical axis 35 is positive, the output-side mirror 22 is rotated anti-clockwise. If the tilt angle θ of the injection optical axis 35 is negative, the output-side mirror 22 is rotated clockwise.

FIG. 25 is an enlarged view showing the vicinity of the output-side mirror 22.

When an injection angle of seed light applied to the output-side mirror 22 with respect to the discharge electrode axis 32 is denoted by θ (>0), a tilt angle of the output-side mirror 22 is denoted by θ2 (>0), a reflection angle of the laser beam reflected by the output-side mirror 22 with respect to the discharge electrode axis 32 is denoted by θ3 (>0), the equation θ3=θ−θ2 is established. This means that, in the fifth embodiment, the reflection angle θ3 at which the seed light is reflected is always smaller than the injection angle θ at which the seed light is input to the output-side mirror 22. Thus, according to the fifth embodiment, a reflected laser beam Z1 when the output-side mirror 22 is tilted is reflected at a lower angle than a reflected laser beam Z0 when the output-side mirror 22 is not tilted. Consequently, the shift amount of the reflected laser beam shifted to the upper side in the drawings can be suppressed.

However, if the tilt angle θ2 is made too large to make the tilt angle θ3 too small, the laser beam width formed by reflecting the laser beam back and forth in the resonator cannot be enlarged. Accordingly, it is required to preliminarily obtain an optimal tilt angle θ2 through experiments.

The experiment results revealed that the optimal tilt angle θ2 of the output-side mirror 22 is 0.04 mrad when the tilt angle of the seed light is 0.6 mrad.

When the tilt angle is set as described above, the reflection angle of the seed light reflected by the output-side mirror 22 is 0.56 mrad (first pass). The reflected laser light is reflected by the rear-side mirror 21 at a same angle as the incident angle, namely at a reflection angle of 0.56 mrad, and again is incident to the output-side mirror 22. The laser light incident to the output-side mirror 22 at a tilt angle of 0.56 mrad is reflected by the output-side mirror 22 at a tilt angle obtained by subtracting the tilt angle θ1 of the output-side mirror 22, namely at a tilt angle of 0.52 mrad (second pass). Subsequently, every time the laser is reflected by the output-side mirror 22, the reflection angle of the laser light is decreased by 0.04 mrad in the same manner. According to the decrease of the reflection angle, the shift amount of the laser beam shifted to the upper side in the drawing is also deceased every time the laser light is reflected back and forth.

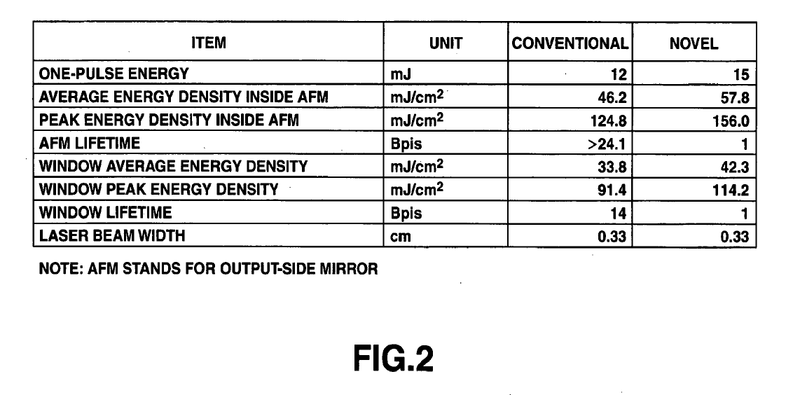

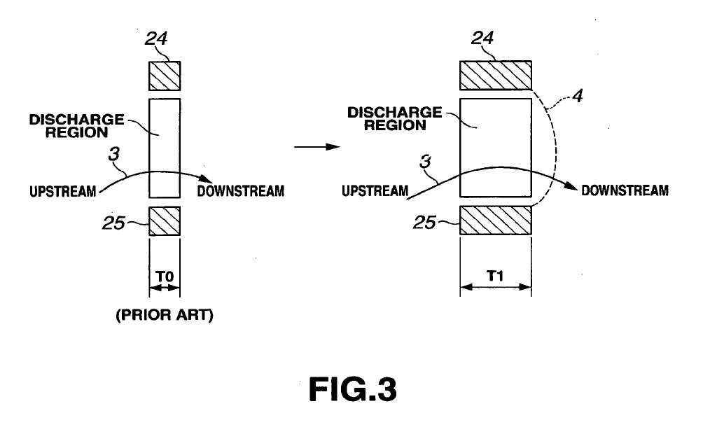

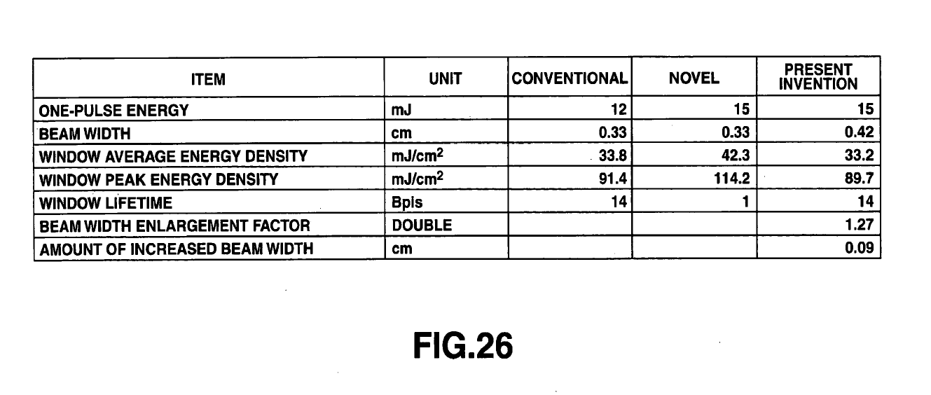

FIG. 26 is a table showing the experimental results of the fifth embodiment in comparison with the results of experiments conducted under the conventional and novel condition shown in FIG. 2.

As described with reference to FIG. 2, the output energy is 15 mJ under the novel condition. In this case, the average energy density applied to the windows is 42.3 mJ/cm², the peak energy density is 114.2 mJ/cm², and the windows' lifetime is one Bpls. The output laser beam width is 0.33 cm.

In contrast, according to the fifth embodiment of the present invention, the laser beam width is enlarged to 0.42 cm. The beam enlargement factor is 1.27. According to the present invention, therefore, the average energy density applied to the windows is 33.2 mJ/cm², and the peak energy density is 89.7 mJ/cm². These values are equivalent to the average energy density and the peak energy density according to the conventional condition shown in FIG. 2. As a result, the windows' lifetime is prolonged to 14 Bpls, the same lifetime as of the conventional condition.

Although the output-side mirror 22 is tilted in FIG. 24, the output-side mirror 22 may be arranged orthogonal to the discharge electrode axis 32, while the rear-side mirror 21 is tilted. In this case, except that the reflection angle with respect to discharge electrode axis 32 is unchanged when the seed light injected at a predetermined injection angle θ with respect to the discharge electrode axis 32 is reflected for the first time by the output-side mirror 22, the subsequent change in the reflection angle of the laser beam is entirely the same as that of FIGS. 23A and 23B.

According to the fifth embodiment as described above, the laser beam width can be enlarged and the laser light can be reflected back and forth within the gain region. Therefore, the discharge energy of the gain region can be utilized effectively.

Although the discharge electrode axis 32 is arranged laterally on the sheet surface in FIG. 24, the discharge electrode axis 32 may be rotated on the sheet surface in FIG. 24 as a modification.

In this case, the discharge electrode axis 32 should be tilted such that laser light reflected by the output-side mirror 22 is not deviated from the gain region G. That is, the discharge electrode axis 32 is rotated clockwise. This makes it possible to prevent the laser light reflected by the output-side mirror 22 from deviating from the gain region. Consequently, the discharge energy can be utilized even more effectively than in the case of FIGS. 23A and 23B.

### Sixth Embodiment

A sixth embodiment is applicable to a MOPO system and a single excimer laser device.

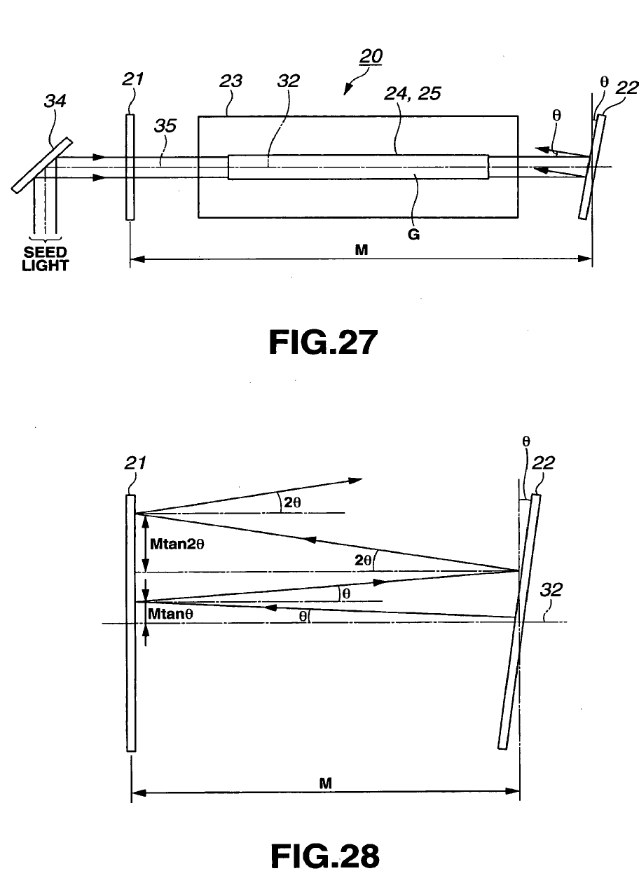

FIG. 27 is a conceptual diagram for explaining the sixth embodiment.

In the sixth embodiment as shown in FIG. 27, the rear-side mirror 21 is arranged orthogonal to the discharge electrode axis 32. The output-side mirror 22 is tilted around an axis extending in the discharge direction of the discharge electrodes 24 and 25, at a tilt angle θ with respect to the rear-side mirror 21, so as to reflect laser light reaching the output-side mirror 22.

Although the output-side mirror 22 is rotated clockwise to make the tilt angle θ in FIG. 27, the output-side mirror 22 may be rotated anti-clockwise to make the tilt angle θ according to the sixth embodiment.

FIG. 28 is a conceptual diagram for explaining how the laser beam is reflected within the resonator according to the sixth embodiment.

Seed light injected in the direction of the discharge electrode axis 32 directly reaches the output-side mirror 22 (first pass). Since the output-side mirror 22 is tilted at the tilt angle θ, the seed light is reflected at a reflection angle θ that is the same as the tilt angle θ. When a distance between the rear-side mirror 21 and the output-side mirror 22 is denoted by M, the laser beam reflected by the output-side mirror 22 is shifted to the upper side in the drawing by M tan θ before reaching the rear-side mirror 21. The laser beam reflected by the rear-side mirror 21 is further shifted to the upper side in the drawing by M tan θ and reaches the output-side mirror 22 (second pass). Since the output-side mirror 22 is tilted at the tilt angle θ, the laser beam incident thereto at the reflection angle θ is reflected at a reflection angle 2θ. The reflected laser beam is shifted to the upper side in the drawing by M tan 2θ before reaching the rear-side mirror 21. The laser beam reflected by the rear-side mirror 21 is further shifted to the upper side in the drawing by M tan 2θ and reaches the output-side mirror 22 (third pass). Subsequently, in the same manner, the reflection angle is increased by θ every time the laser beam is reflected by the output-side mirror 22, while at the same time the shift amount is increased. In other words, the laser beam is shifted to the upper side in the drawing as the number of passes increased from the first to second pass, from the second to third pass, and so forth. This means that the laser beam width is enlarged to the upper side in the drawing according to the sixth embodiment as well.

According to the sixth embodiment as described above, the width of the laser beam output by the output-side mirror 22 can be enlarged. Accordingly, the energy density of the laser beam applied to the windows provided in the laser chamber in the resonator can be reduced, and thus deterioration of the windows can be suppressed.

### Seventh Embodiment

A seventh embodiment is applicable to a MOPO system using seed light.

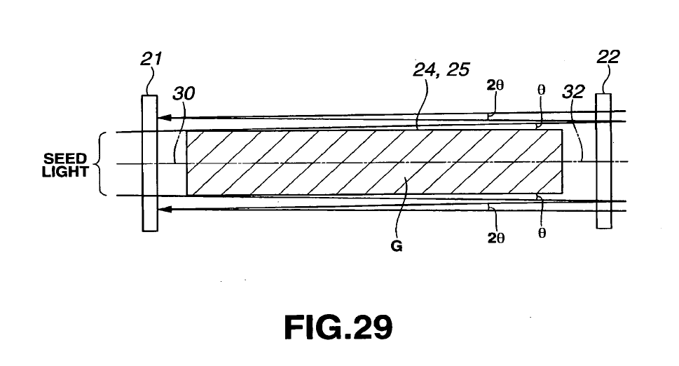

FIG. 29 is a conceptual diagram for explaining the seventh embodiment.

In the case of the seventh embodiment as shown in FIG. 29, seed light generated by an oscillation stage laser (not shown) is injected into a resonator with a spread angle in a vertical direction on the sheet surface. The spread angle is an angle made by deviating vertically in the drawing with respect to a light beam parallel to the resonator optical axis 30. In the case of FIG. 29, the spread angle is defined by a total angle 20 of the upper and lower tilt angles θ on the paper sheet with respect to the resonator optical axis 30.

According to FIG. 29, a laser beam deviated to the upper side in the drawing reaches the output-side mirror 22 at the tilt angle θ and is then reflected thereby. On the other hand, a laser beam deviated to the lower side in the drawing reaches the output-side mirror 22 at the tilt angle θ and is then reflected thereby.

The subsequent mode of reflection of these two laser beams is entirely similar to the case of the third embodiment in which seed light injected into the laser chamber 23 at a tilt angle θ with respect to the resonator optical axis 30. In other words, the laser beam deviated to the upper side in the drawing has its laser beam width enlarged to the upper side in the drawing. Similarly, the laser beam deviated to the lower side in the drawing has its laser beam width enlarged to the lower side of the drawing.

According to the seventh embodiment as described above, the width of the laser beam reflected back and forth within the resonator can be enlarged. Therefore, the energy density of the laser beam applied to the windows provided in the laser chamber in the resonator can be reduced, and hence deterioration of the windows can be suppressed.

### Eighth Embodiment

In the embodiments described so far, the rear-side mirror and the output-side mirror forming the resonator are both of a flat type. However, according to the present invention, the mirrors forming the resonator need not necessarily be of a flat type.

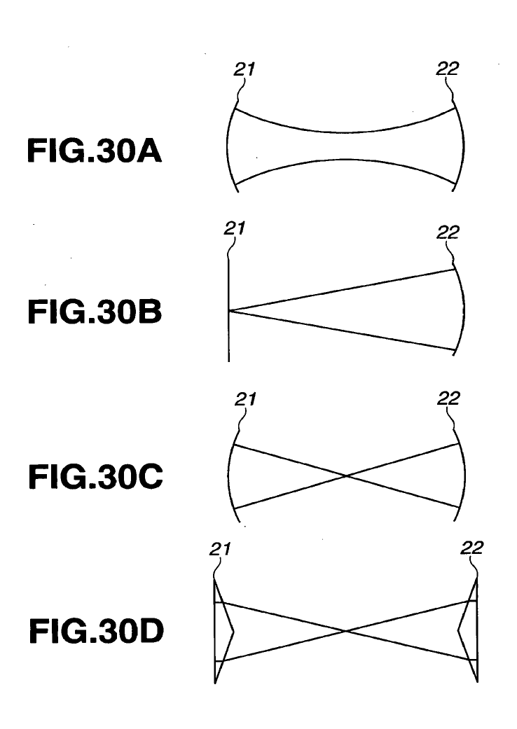

FIGS. 30A to 30D are conceptual diagrams for explaining an eighth embodiment.

FIG. 30A shows a case of confocal mirror arrangement, in which a rear-side mirror 21 and an output-side mirror 22 both of which are concave mirrors having a same shape are arranged with the concave surfaces facing each other so as to have a confocal point.

FIG. 30B shows a case of semi-confocal mirror arrangement, in which an output-side mirror 22 which is a concave mirror is arranged such that its concave surface faces a rear-side mirror 21, while the focal point of the output-side mirror 22 is set on the surface of the rear-side mirror 21.

FIG. 30C shows a case of radial mirror arrangement. Specifically, a rear-side mirror 21 and an output-side mirror 22 are arranged such that their surfaces having a common radius face each other. Obviously, the focal point of the mirrors resides at the center of the radius.

FIG. 30D shows a case in which a rear-side mirror 21 and an output-side mirror 22 are both formed by a triangular prism.

The resonator configurations as described above also enable enlargement of the laser beam width by repeatedly reflecting the laser beam back and forth within the resonator.

The eighth embodiment is applicable to both a MOPO system and a single chamber laser device.

### Ninth Embodiment

The energy density applied to the output-side mirror 22 can be decreased further by combining the technique to enlarge the laser beam width with a well-known beam expander (BEX) technique. An embodiment employing such combination will be described as a ninth embodiment of the present invention.

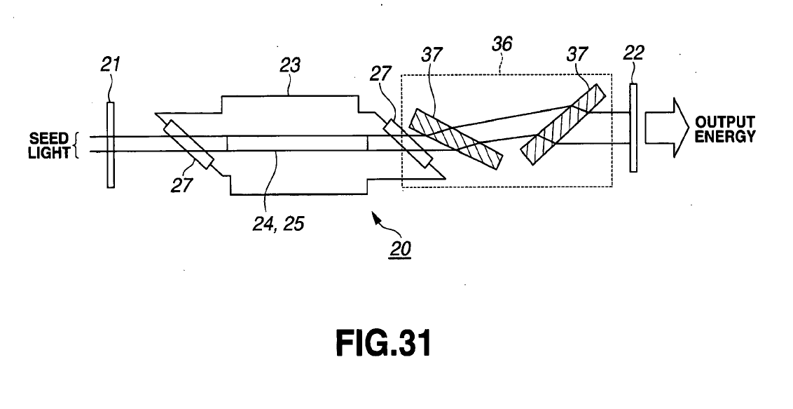

FIG. 31 is a conceptual diagram for explaining the ninth embodiment. Although the following description will be made using an amplification stage laser of a MOPO system shown in FIG. 31, the ninth embodiment is also applicable to a single chamber laser device.

As shown in FIG. 31, a laser chamber 23 and a beam expander 36 are provided in a resonator comprised of a rear-side mirror 21 and an output-side mirror 22. A laser beam reflected and amplified in the resonator has its laser beam width enlarged by the technique as described in the first to eighth embodiments.

The beam expander 36 has wedge-shaped permeable optical elements 37, 37 arranged on a laser optical axis, and is able to enlarge laser light.

According to the ninth embodiment, the width of a laser beam applied to windows 27, 27 provided on the laser chamber 23 can be enlarged, and additionally the width of the laser beam applied to the output-side mirror 22 also can be enlarged by the beam expander 36.

This makes it possible to reduce the energy density of laser light applied to the output-side mirror 22, and thus deterioration of the output-side mirror 22 can be suppressed even if high output energy is output from the output-side mirror 22.

In the MOPO system described above, the seed light generated by the oscillation stage laser 10 is invariably injected from the rear face of the rear-side mirror 21. This method is referred to as the rear injection method. In the present invention, the method of injecting the seed light is not limited to the rear injection method, but other injection methods can be employed.

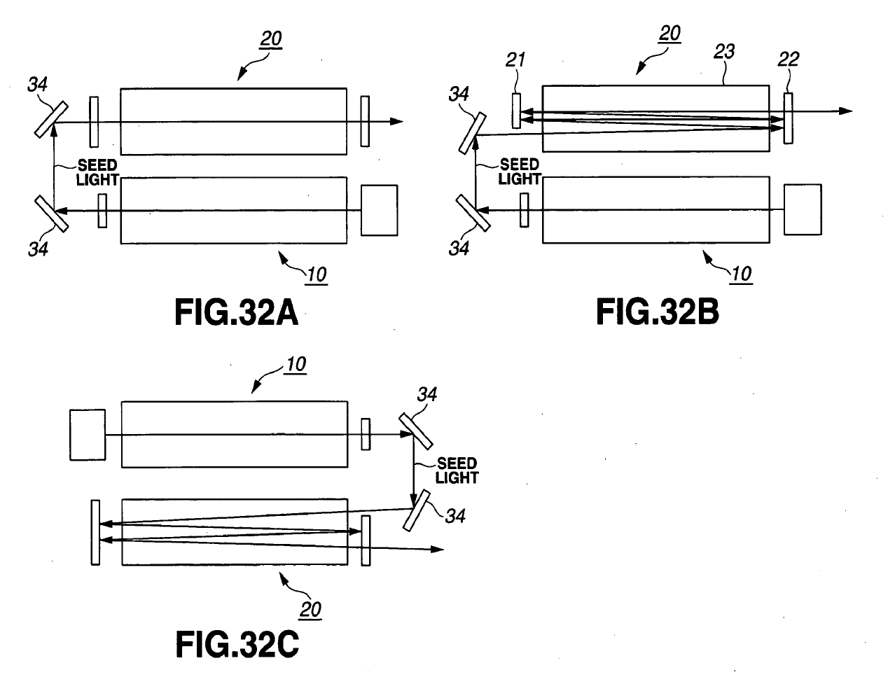

FIGS. 32A to 32C are conceptual diagrams for explaining representative injection methods.

FIG. 32A illustrates the rear injection method in which seed light generated by the oscillation stage laser 10 is guided by laser light guide mirrors 34, 34 and injected into the amplification stage laser 20 from the rear face (left side in the drawing) of the rear-side mirror 21.

FIG. 32B illustrates a side injection method in which seed light generated by the oscillation stage laser 10 is guided by the laser light guide mirrors 34, 34 and directly injected into the laser chamber 23 without passing through the rear-side mirror 21. In the case of the side injection method, therefore, a high reflection mirror can be used as the rear-side mirror 21 so that the laser energy in the resonator can be amplified efficiently.

FIG. 32C illustrates a front injection method, in which seed light generated by the oscillation stage laser 10 is guided by laser optical path changeover mirrors 35, 35 to the vicinity of the output-side mirror 22, and directly injected into the laser chamber 23. In the case of the front injection method, therefore, a high reflection mirror can be used as the rear-side mirror 21, so that the laser energy in the resonator can be amplified efficiently.

For example, the side injection method and the front injection method are suitable for injecting the seed light while tilting the same with respect to the resonator optical axis with the rear-side mirror 21 and the output-side mirror 22 arranged parallel to each other. In this case, the width of the laser beam in the resonator may be optimized by adjusting the reflection angle of the mirrors 21 and 22.

In the embodiments described above, the laser beam width is enlarged by enlarging the gain region width without changing the discharge electrode width. However, if it is convenient, the discharge electrode width may be enlarged to thereby enlarge the gain region width, so that the laser beam width is enlarged as a result.

1-6. (canceled)

7. An excimer laser device having laser beam width enlarging means for enlarging width of a laser beam applied to an optical element provided in a laser chamber so that an energy density of the laser beam is reduced within such a range that a laser output of no less than a desired level is obtained,
wherein the excimer laser device is used for an amplification stage laser of a two-stage laser device comprised of an oscillation stage laser and the amplification stage laser,
wherein the laser beam width enlarging means comprises:
means for injecting seed light generated by the oscillation stage laser into the amplification stage laser chamber while tilting the seed light with respect to an axis of the discharge electrode axes extending parallel to a longitudinal direction, in a plane parallel to an electrode width direction of the discharge electrodes;
means for causing the injected seed light to pass through a substantially entire gain region between the discharge electrodes; and
means for arranging one of the rear-side mirror and the output-side mirror orthogonal to an axis parallel to the longitudinal direction of the discharge electrodes, while arranging the other mirror such that laser light reflected thereby passes through the gain region.

8. The excimer laser device according to claim 7, wherein the means for arranging the other mirror is means for tilting one mirror with respect to the other mirror around an axis extending in a direction orthogonal to both of the axis extending parallel to the longitudinal direction of the discharge electrodes and the axis of an electrode width direction of the discharge electrodes.

9. The excimer laser device according to claim 7, wherein the laser beam width enlarging means is means for arranging one of the rear-side mirror and the output-side mirror orthogonal to an axis extending along a longitudinal direction of the discharge electrodes, while arranging the other mirror such that laser light reflected thereby travels away from a gain region between the discharge electrodes.

10. The excimer laser device according to claim 9, wherein the means for arranging the mirror is means for tilting one mirror with respect to the other mirror around an axis orthogonal to both of the axis of the longitudinal direction of the discharge electrodes and the axis of an electrode width direction of the discharge electrodes.

11. (canceled)

12. The excimer laser device according to claim 7, wherein a beam expander is provided between the laser chamber of the amplification stage laser and the output-side mirror.
